(19) United States
(12) Patent Application Publication
(10) Pub. No.: US 2026/0204837 A1
(43) Pub. Date: Jul. 16, 2026

(54) SEALING ARRANGEMENT FOR AN ELECTRICAL CONNECTION, PLUG CONNECTOR AND ELECTRICAL CONNECTION

(71) Applicant: TE Connectivity Solutions GmbH, Schaffhausen (CH)

(72) Inventors: Andreas LEONHARD, Bensheim (DE); Dennis MEININGER, Bensheim (DE)

(21) Appl. No.: 19/446,125

(22) Filed: Jan. 12, 2026

(30) Foreign Application Priority Data
Jan. 13, 2025 (DE) 102025100963.5

(51) Int. Cl. H01R 13/52

(52) U.S. Cl. CPC H01R 13/5219

(57) ABSTRACT

A sealing arrangement for sealing an electrical connection, wherein the electrical connection has a plurality of interfaces at which a plug and a mating connector of the electrical connection are matable with each other along a mating direction, includes a first sealing section, which is assigned to a first interface of the plurality of interfaces and a second sealing section, which is assigned to a second interface of the plurality of interfaces. The first and the second sealing section each have a plurality of sealing projections arranged one behind the other in the mating direction. The sealing projections of the first sealing section are arranged offset in the mating direction to the sealing projections of the second sealing section. The sealing arrangement may be provided at a plug connector of an electrical connection.

### CROSS REFERENCE TO RELATED APPLICATIONS

This application claims the benefit of DE Application No. 102025100963.5, filed 13 Jan. 2025, the subject matter of which is herein incorporated by reference in its entirety.

### BACKGROUND OF THE INVENTION

The subject matter herein relates to a sealing arrangement for an electrical connection, a plug connector, and an electrical connection.

Electrical connections for transmitting electrical energy or signals are increasingly used in environments with extreme temperatures, in the vicinity of moisture and/or liquids. Against these environmental influences, the connectors must be designed in such a way that they reliably maintain the transmission quality and can withstand the influences at the respective place of use or area of application, for example in the automotive sector.

Connectors for such an electrical connection are often designed with a seal or are sealed to prevent liquids and/or dust from penetrating into the connector. Especially with modular connectors that integrate multiple contact systems in a common housing, it is sometimes necessary to seal individual modules individually. Such individual sealing significantly increases the required mating force during assembly, which impairs the usability of the electrical connection.

There is therefore a need for a sealing arrangement for electrical connections which has a plurality of seals, in which the mating force is reduced, which is simple to manufacture and seals reliably.

### BRIEF DESCRIPTION OF THE INVENTION

In one embodiment, a sealing arrangement is provided for sealing an electrical connection, wherein the electrical connection has a plurality of interfaces at which a plug and a mating connector of the electrical connection are matable with each other along a mating direction. The sealing arrangement includes a first sealing section, which is assigned to a first interface of the plurality of interfaces; a second sealing section, which is assigned to a second interface of the plurality of interfaces; wherein the first and the second sealing section each have a plurality of sealing projections arranged one behind the other in the mating direction; and wherein the sealing projections of the first sealing section are arranged offset in the mating direction to the sealing projections of the second sealing section.

This solution with the offset arrangement of the sealing projections enables a better and more efficient distribution of the force peaks during mating, whereby the total required mating force during the mating of the mating connector and the plug of an electrical connection is reduced. This promotes a compact design by eliminating the need for larger levers, while at the same time favoring a reduction in material wear.

The subject matter herein can be further improved by the following configurations, which are in themselves advantageous and can be combined with one another in any way.

The terms plug and mating connector do not restrict the respective component to the male embodiment or the complementary female embodiment. The terms are merely intended to clearly distinguish between one part and the complementary part. The plug can be a male or a female plug; the mating connector can accordingly be designed complementary thereto.

The first and/or the second sealing section can have an opening, a through-opening, in which the plug and/or the mating connector can be inserted. The mating connector can be received in the through-opening, in particular in the embodiment of the plug as a female plug. Alternatively, the through-opening of the first and/or the second sealing section can each receive the plug configured as a male plug. The respective sealing section can accordingly rest against a wall of the plug or the interface, i.e., against a plug wall and/or an interface wall.

The terms “first” and “second” serve exclusively for conceptual differentiation and can be used interchangeably as required. The properties that apply to components with the designation “first” can equally apply to “second” components, and vice versa.

The sealing section can have a sealing section wall that surrounds the through-opening, in particular around the mating direction. The sealing section wall can rest on one side of the sealing section wall against the plug wall or interface wall. On the side of the sealing section wall facing away from the interface wall, the sealing projections can extend into the through-opening in a direction transverse to the mating direction or can project towards the through-opening. An alternative embodiment can have sealing projections that point away from the through-opening, in particular along the direction transverse to the mating direction. If the plug or the interface is configured as a male plug, the respective sealing projections can protrude from the outer side of the sealing section wall and from the outer side of the plug wall or interface wall. This provides the advantage that the sealing arrangement is more easily accessible, so that maintenance or replacement of the respective sealing arrangement and/or the respective sealing section can be carried out more quickly.

In the mating direction, the sealing projections of the first sealing section and/or the sealing projections of the second sealing section can be spaced apart from one another. For example, the sealing projections of the first sealing section and/or the sealing projections of the second sealing section can be separated from one another by recesses, especially in the mating direction. A recess can thus be located between two sealing projections of a sealing section.

Sealing projections and recesses of the first sealing section and/or sealing projections and recesses of the second sealing section can be manufactured from one part. The first sealing section and/or the second sealing section can consequently be configured monolithically or, synonymously, in one piece. A further embodiment is characterized by a monolithically configured sealing arrangement, in which the sealing sections can be connected to one another and accordingly the first sealing section can be connected to the second sealing section. The sealing arrangement can, for example, be configured as a mat seal with monolithically connected sealing sections. This simplifies the manufacturing process, as less assembly effort is required. Fewer components are needed and, moreover, monolithic sealing arrangements and/or sealing sections can be manufactured with high dimensional accuracy.

An embodiment of the sealing arrangement can also have individual radial seals and/or individual and separate sealing sections. This offers the advantage of flexible adaptability to external conditions and individual, especially modular, plug connectors and/or electrical connections.

Another embodiment can comprise sealing projections arranged one behind the other in the mating direction per sealing section, which are not connected to each other. This facilitates handling, as each sealing projection can be inserted or removed separately and the installation of the sealing arrangement can be adapted to specific requirements.

In one embodiment, the sealing projections of the first sealing section and/or the sealing projections of the second sealing section can be spaced equally far from one another, in particular along the mating direction. This offers the advantage of simple and accelerated manufacturing, as fewer individual adjustments are required, especially when standardized distances are used.

The sealing projections can be configured as sealing lips. The respective sealing projection can have a maximum which defines the point of the sealing projection where the sealing projection projects furthest transverse to the mating direction. In the direction transverse to the mating direction, the maximum consequently marks the highest point or the apex of the respective sealing projection, which is furthest away from the sealing section wall.

The sealing projections of the first sealing section can be located at the same height in the mating direction as the recesses of the second sealing section. This offers the advantage of a reduction in the mating force when, for example, a first mating connector is simultaneously inserted into the first sealing section and a second mating connector is inserted into the second sealing section along the mating direction. In particular, the respective mating connector can be inserted through the through-opening of the respective sealing section.

The sealing projections of the first sealing section and/or the sealing projections of the second sealing section, and also the recesses of the first sealing section and/or the recesses of the second sealing section, can be identically configured. For example, each sealing projection of the first sealing section and/or each sealing projection of the second sealing section can have the same width in the mating direction. The width of the sealing projections of the first sealing section and/or the width of the sealing projections of the second sealing section can be identical along the mating direction. The width can be measured from inflection point to inflection point of a sealing projection along the mating direction.

The maxima or apices of the sealing projections of a sealing section, for example of the first sealing section, can have the same distance from one another in the mating direction. The apices can be located on a straight line that runs parallel to the mating direction. Analogously, the recesses can each have minima that are located closest to the sealing section wall in the direction transverse to the mating direction, and which can likewise lie on a straight line parallel to the mating direction. A minimum thereby marks the deepest point of a recess in the direction transverse to the mating direction.

In one configuration, sealing projections and recesses can be sinusoidal in combination along the mating direction. In particular, the sealing section can be configured sinusoidally on a sealing side. In the present document, the sealing side is the side of the sealing section wall on which the sealing projections project or on which the through-opening is located.

The distance between a first sealing projection of the first sealing section and a first end of the first sealing section can be greater along the mating direction than the distance between two sealing projections of the first sealing section arranged one behind the other in the mating direction. The first end of the first sealing section can be the end of the sealing section along the mating direction that is closest to the first sealing projection. For example, the first end can directly face the mating connector in the mating direction. The first sealing projection can be the sealing projection of the respective sealing section that is first touched by the mating connector during mating. Analogously, this configuration can apply to the second sealing section.

Likewise, the distance between the apex of the first sealing projection of the first sealing section and the insertion opening of the assigned interface along the mating direction can be greater than the distance between the apices of two sealing projections of the first sealing section arranged one behind the other in the mating direction; the same can apply to the second sealing section.

The distance between a last sealing projection of the first sealing section and a second end of the first sealing section and/or the distance between a last sealing projection of the second sealing section and a second end of the second sealing section can be smaller than or equal to the distance between two sealing projections of the first sealing section arranged one behind the other in the mating direction and/or between two sealing projections of the second sealing section arranged one behind the other in the mating direction. The last sealing projection can be the sealing projection of a sealing section that is last touched by the mating connector when mating the electrical connection. The second end of the respective sealing section can be the end that is furthest away from the mating connector in the mating direction.

In the same way, the distance between an apex of the first sealing projection of the, for example, first sealing section and a second end of the first sealing section can be smaller than or equal to the distance between the apices of two sealing projections of the first sealing section arranged one behind the other in the mating direction.

In an alternative embodiment, the distance between the first sealing projection of the first sealing section and the first end of the first sealing section can be smaller than or equal to the distance between two sealing projections of the first sealing section arranged one behind the other in the mating direction. The distance between the last sealing projection of the first sealing section and the second end of the first sealing section can be greater than the distance between two sealing projections of the first sealing section arranged one behind the other in the mating direction; this can also be transferred to the second sealing section.

The first and the second sealing section can be arranged on a common plane perpendicular to the mating direction. The ends of the sealing sections facing the mating connector, i.e., the first ends, can lie on the common plane perpendicular to the mating direction. In particular, front edges of the sealing sections can lie on the common plane perpendicular to the mating direction.

An end of the respective sealing section can be flush with an end of the interface. An end of the first sealing section can in particular also be flush with an end of the second sealing section, for example, the first end of the first sealing section is flush with the first end of the second sealing section. The first end of the first sealing section and the first end of the second sealing section can be in a row transverse to the mating direction and aligned on the common plane. This enables a precise alignment that ensures uniform force transmission and sealing.

The first and the second sealing section can be identically configured. The first sealing section can be arranged rotated by 180 degrees around an axis next to the second sealing section, wherein the axis can run perpendicular to the mating direction, along a direction transverse to the mating direction. The sealing sections can thus be identical and insertable inverted relative to each other. This reduces the total number of parts to be manufactured and simplifies installation.

The first and/or the second sealing section can extend along a circumferential direction transverse to the mating direction. In particular, the first and/or the second sealing section can extend in a ring shape along a circumferential direction. The shape can be dependent on the respective interface and be individually adapted. The sealing sections can thus have the same contour and/or size as the respective interface to which they are assigned.

In the case of an electrical connection with three or more interfaces, the sealing arrangement can have three or more sealing sections.

The third sealing section or every odd-numbered sealing section can correspond to the first sealing section. The fourth or every even-numbered sealing section can correspond to the second sealing section.

The arrangement or positioning of the sealing sections corresponding to the first sealing section, and the arrangement of the sealing sections corresponding to the second sealing section, are variable and individually adaptable on the common plane. Whether a sealing section corresponding to the first sealing section is in an even or odd position and/or whether a sealing section corresponding to the second sealing section is in a position next to a sealing section configured as a first sealing section is irrelevant.

Thus, next to a sealing section corresponding to the first sealing section, another identical sealing section corresponding to the first sealing section can be arranged. This does not impair the function of the sealing arrangement, as long as the sealing arrangement has at least one second sealing section with sealing projections that are offset to the sealing projections of the first sealing section. Preferably, the sealing arrangement can have the same number of sealing sections with sealing projections at the height of the first sealing section as the number of sealing sections with sealing projections at the height of the second sealing section.

The sealing arrangement can have sealing sections that are arranged in a row, for example in a direction transverse to the mating direction. The sealing arrangement can have sealing sections that are arranged in a grid, for example in a 2×2 grid or a 2×4 grid. The sealing sections can in particular lie in such a grid or row arrangement on the common plane.

In another embodiment, a plug connector is provided with a plurality of interfaces that includes a sealing arrangement as described above, wherein in the mated state the first sealing section seals a first interface and the second sealing section seals a second interface.

The plug connector can have a plurality of plugs, which are configured to be connectable with a mating connector. The number of plugs can correspond to the number of interfaces. The interface can be the location where the plug and mating connector touch in the mated state.

The plurality of plugs can have a plurality of plug openings or insertion openings, in particular if the plugs are configured as female. One sealing section can be provided for each insertion opening. A sealing section can extend along the circumferential direction of the respective insertion opening. The plug connector opening and/or insertion opening can be any polygonal-shaped opening.

The first and/or the second sealing section can be arranged or rest on an interface wall and/or plug connector wall or plug wall along the circumferential direction, for example on the inner side of the interface wall or plug wall. Alternatively, the respective sealing section can rest on the outer side of the interface wall or plug wall, for example if it is a male plug.

The first and/or the second sealing section can have sealing projections on the sealing side, which protrude transversely to the mating direction away from the interface wall.

The apices of the respective sealing projections of a sealing section can be located further away from the interface wall than the minima of the at least one recess of the respective sealing section.

In a further embodiment, an electrical connection is provided including a plug connector as described above and at least one mating connector, which can be part of a mating connector plug. The mating connector plug can consist of several mating connectors. The number of mating connectors can correspond to the number of plugs and/or interfaces. The sealing arrangement as described above can be arranged sealingly between the plug of the plug connector and the mating connector in the mated state of the plug connector and mating connector. In particular, in the mated state of the plug connector and mating connector plug, the sealing arrangement can be arranged sealingly between the plug and the mating connector.

The sealing projections of the sealing arrangement, which is arranged on the plug connector, can be supported on the inner side or the outer side of the mating connector and/or the mating connector plug in the mated state.

In the following, the invention is described by way of example with reference to the drawings. In the drawings, the same reference signs are always used for elements that correspond to each other in terms of function and/or structure. According to the above description, a feature of the exemplary embodiment can be omitted if, in a specific application, the technical effect associated with this feature is not important. Conversely, according to the above description, a feature not yet present can also be added to the exemplary embodiment if, in a specific application, the technical effect of the feature to be added is important.

### BRIEF DESCRIPTION OF THE DRAWINGS

The figures show:

FIG. 1 a schematic depiction of an embodiment of a sealing arrangement;

FIG. 2 a sectional view of an embodiment of the sealing arrangement;

FIG. 3 a schematic depiction of a sealing arrangement on a plug connector;

FIG. 4 a sectional view of an embodiment of the sealing arrangement in a plug connector;

FIG. 5 a sectional view of another embodiment of the sealing arrangement in a plug connector;

FIG. 6 a schematic depiction of an embodiment of the sealing arrangement with a plurality of sealing sections;

FIG. 7 a sectional view of an embodiment of an electrical connection with a plug connector and a mating connector plug; and

FIG. 8 a sectional view of another embodiment of the electrical connection in the mated state.

### DETAILED DESCRIPTION OF THE INVENTION

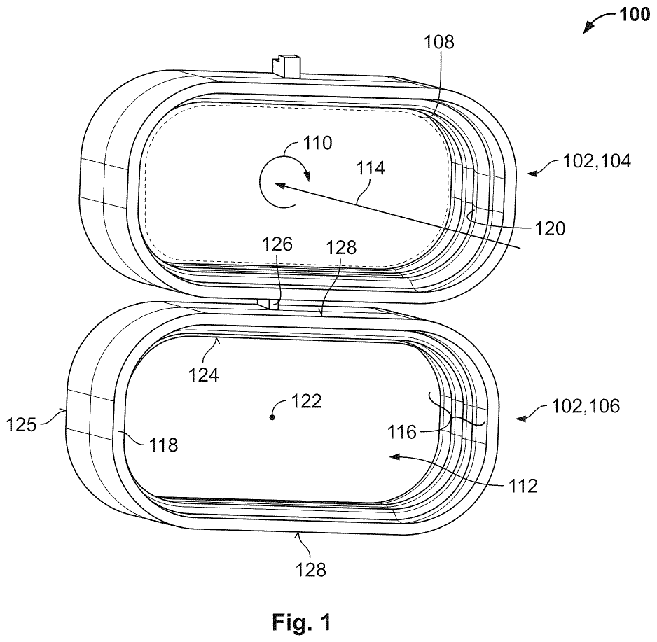

FIG. 1 shows a sealing arrangement 100 with sealing sections 102. In this embodiment, a first sealing section 104 is arranged next to a second sealing section 106. The sealing sections 102, in particular the cross-sections 108 of the sealing sections 102, can be configured in a ring shape and, for example, form an ellipse or a circle along a circumferential direction 110.

The sealing sections 102 can have through-openings 112, which extend along a mating direction 114 transverse to the circumferential direction 110.

A sealing section 102 can have a plurality of sealing projections 116. The plurality of sealing projections 116 can project or protrude from a sealing section wall 118 that surrounds the through-opening 112 along the circumferential direction 110. In FIG. 1, the sealing projections 120 of the plurality of sealing projections 116 protrude from the sealing section wall 118 towards the through-opening 112, in particular towards the center 122 of the through-opening 112. The side to which the sealing projections 120 protrude from the sealing section wall 118 can be defined as a sealing side 124.

The sealing side 124 can also be an outer side 125 of the sealing section wall 118, wherein the sealing projections 120 of the plurality of sealing projections 116 protrude away from the sealing section wall 118 and from the through-opening 112.

Along the mating direction 114, the sealing projections 120 in the plurality of sealing projections 116 can be arranged one behind the other.

The first sealing section 104 and the second sealing section 106 can be monolithically configured and connected to each other by a material section or a material bridge 126. Another embodiment of the sealing arrangement 100 provides for sealing sections 102 that are configured separately from each other and can be installed separately from each other.

At least a part of the outer side 125 of the first sealing section 104, for example a longitudinal side 128 of the first sealing section 104, can face at least a part of the outer side 125 of the second sealing section 106, such as a longitudinal side 128 of the second sealing section 106.

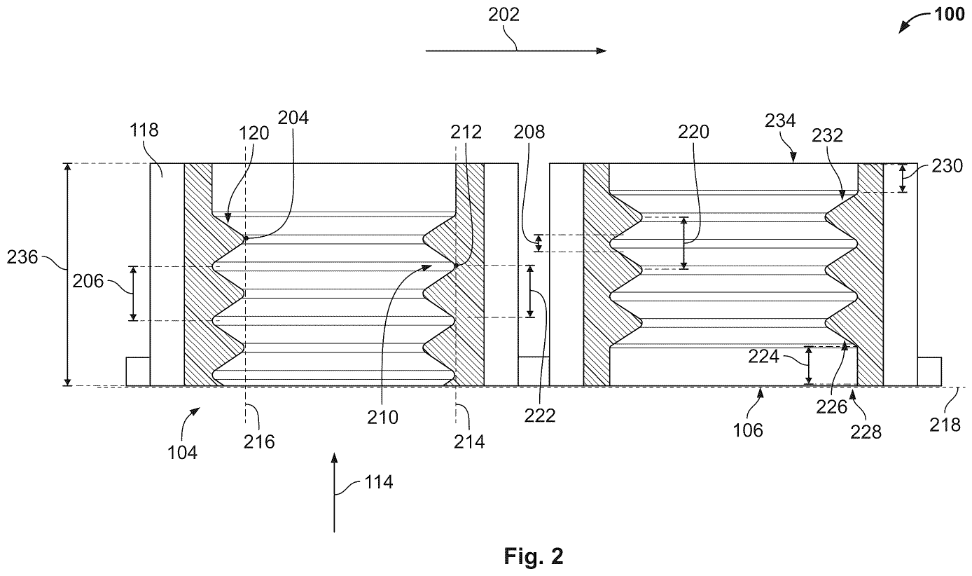

FIG. 2 shows an embodiment of the sealing arrangement 100 with a first sealing section 104 and a second sealing section 106, which are arranged next to each other along a direction 202 transverse to the mating direction 114. Also in this depiction, the sealing projections 120 are arranged one behind the other along the mating direction 114.

The sealing projection 120 can be configured as a sealing lip. Each sealing projection 120 can have a maximum or an apex 204, which is furthest away from the sealing section wall 118 along the direction 202 transverse to the mating direction 114.

A sealing projection 120 can have a width 206 along the mating direction 114. The width 206 of the sealing projection 120 can be greater than the distance 208 between two sealing projections 120 of a sealing section 102.

Between two sealing projections 120, the sealing section 102 can have a recess 210. The recess 210 can connect two sealing projections 120 that are arranged one behind the other along the mating direction 114. In one embodiment, the recesses 210 can completely separate two sealing projections 120 arranged one behind the other.

The recess 210 can have a minimum 212, which is the point of the recess 210 that is arranged closest to the sealing section wall 118 in the direction 202 transverse to the mating direction 114. The minima 212 can be arranged on a minima-line 214 parallel to the mating direction 114. Likewise, the maxima or apices 204 can be arranged on a maxima-line 216 parallel to the mating direction 114.

The sealing sections 102, in particular the first sealing section 104 and the second sealing section 106, can be arranged next to each other on a common plane 218. This common plane 218 can run transverse or perpendicular to the mating direction 114, for example along the direction 202 transverse to the mating direction 114.

The distance 220 in the mating direction 114 between the maxima 204 of two sealing projections 120 can have the same value as the distance 222 between the minima 212 of a sealing section 102. The distance 224 between a first sealing projection 226 and a first end 228 of a sealing section 102 can be greater than the width 206 of a sealing projection and/or greater than the distance 208 between two sealing projections 120 arranged one behind the other, and/or greater than the distance 220 between the maxima 204 of two sealing projections 120 arranged one behind the other in the mating direction 114.

Analogously, the distance 230 between a last sealing projection 232 and a second end 234 of the sealing section can be smaller than the width 206 of the sealing projection 120 and/or than the distance 208 between two sealing projections 120 and/or the distance 220 between the maxima 204 of two sealing projections 120 arranged one behind the other.

The recess 210 can be configured opposite to the sealing projection 120. Sealing projection 120 and recess 210 can be configured together in a wave-like, for example sinusoidal, manner along the mating direction 114.

The first sealing section 104 and the second sealing section 106 can have a height 236 along the mating direction 114, which has the same value.

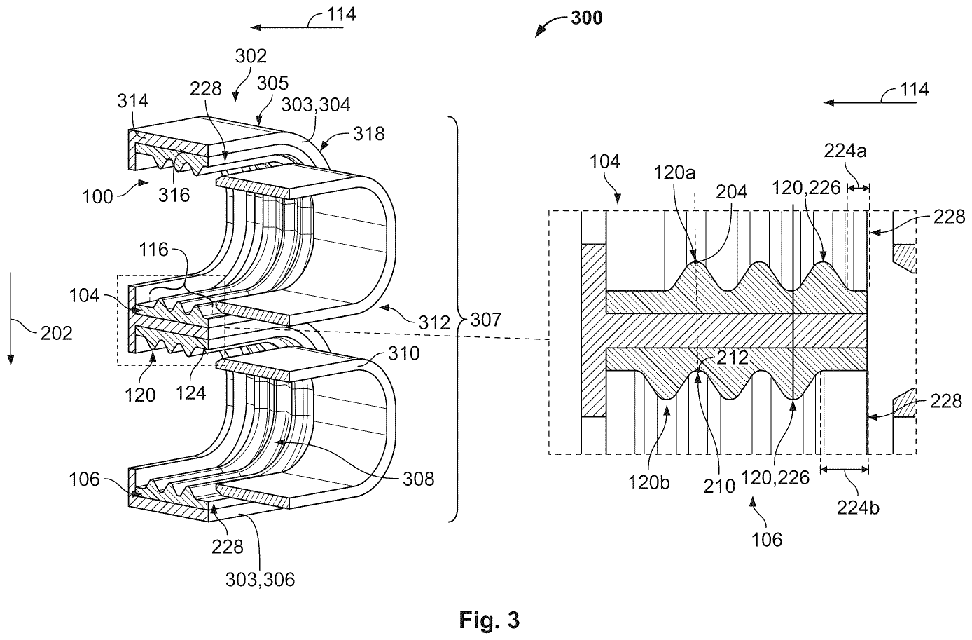

FIG. 3 shows an embodiment of the sealing arrangement 100 for an electrical connection 300. The electrical connection 300 has a plug connector 302 with interfaces 303 and plugs 305. The plug connector 302 can have a first interface 304 and a second interface 306, which can belong to a plurality 307 of interfaces 303.

The interfaces 304, 306 can each have an insertion opening 308, into which a mating connector 310 of a mating connector plug 312 can be inserted in the mating direction 114.

The sealing arrangement 100 can be arranged at the respective interfaces 304, 306 of the plug connector 302. Each interface 304, 306 can be assigned a sealing section 104, 106. Analogously, each plug 305 can be assigned a respective sealing section 102. For example, the first sealing section 104 can be arranged or attached to an interface wall or plug wall 314 of the first interface 304.

The sealing sections 102 can be arranged on the inner side 316 of the respective interface wall 314. The sealing projections 120 can protrude into the insertion opening 308 in the direction 202 transverse to the mating direction 114.

An alternative embodiment can have a sealing arrangement 100 which is arranged on an outer side 318 of the interface wall or plug wall 314. The mating connector plug 312 can accordingly be configured as a female mating connector, into which the plug connector 302, in particular the plugs 305, can be inserted.

The sealing arrangement 100 can have a plurality of sealing projections 116, for example, three sealing projections 120 per sealing section 102. In FIG. 3, the sealing side 124 is located on the inner side 316 of the plug wall 314.

An end 318 of the interface 304, 306 can be flush with an end 228, 234 of a sealing section 102.

The sealing arrangement 100 can have a first sealing section 104, which is arranged relative to the second sealing section 106 such that the distance 224a between a first sealing projection 120, 226 and a first end 228 of the first sealing section 104 is smaller than the distance 224b between a first sealing projection 120 and a first end 228 of the second sealing section 106.

The sealing projection 120a of the first sealing section 104 is preferably arranged offset to a sealing projection 120b of the second sealing section 106 along the mating direction 114. In a further embodiment, the sealing projection 120a of the first sealing section 104 can be located directly opposite a recess 210 of the second sealing section 106 in the direction 202 transverse to the mating direction 114. The apex 204 of the sealing projection 120a of the first sealing section 104 can thus lie on the same line as the minimum 212 of the second sealing section 106, along the direction 202 transverse to the mating direction 114.

Each sealing projection 120 of the plurality of sealing projections 116 of the first sealing section 104 can be located opposite a respective recess 210 of the second sealing section 106.

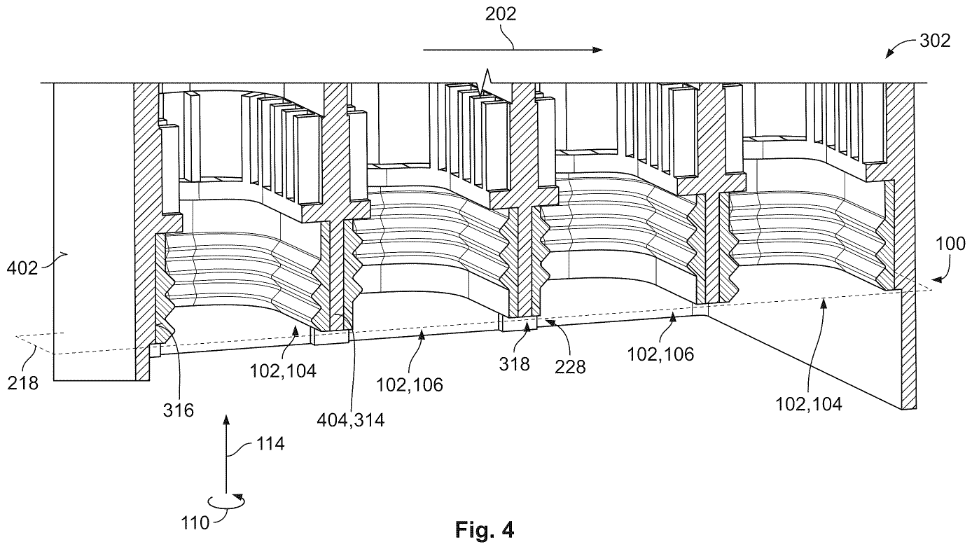

In FIG. 4, an embodiment with a plug connector 302 and a sealing arrangement 100 is shown. In this depiction, the sealing arrangement 100 has a total of four sealing sections. Other embodiments of the sealing arrangement 100 can have any number of sealing sections 102. The number of sealing sections 102 is freely adaptable and modular, depending on the respective plug connector 302 or the electrical connection 300.

The sealing arrangement 100 can have several sealing sections 102 configured as first sealing sections 104 and several sealing sections 102 configured as second sealing sections 106. For example, the sealing arrangement 100 can have two sealing sections 102 with sealing projections 120 at the height of the first sealing section 104 and two sealing sections 102 with sealing projections 120 at the height of the second sealing section 106. Along a direction 202 transverse to the mating direction 114, a first sealing section 104 can be arranged next to a second sealing section 106.

Two identical sealing sections 102, for example two sealing sections 102 with sealing projections 120 at the height of the second sealing section 106, can also be arranged along the direction 202 transverse to the mating direction 114. Overall, the sealing arrangement can have the same number of sealing sections 102 with sealing projections 120 at the height of the first sealing section 104 as sealing sections 102 with sealing projections 120 at the height of the second sealing section 106.

An alternative embodiment of the sealing arrangement 100 can alternately have a first sealing section 104 and a second sealing section 106 along at least one direction 202 transverse to the mating direction 114, so that, viewed from an outer side 402 of the plug connector 302, every odd position has a first sealing section 104 and every even position has a second sealing section 106.

The respective sealing sections 102 can be arranged on the inner side 316 of the interface wall 314. The respective sealing section 102 can extend along the circumferential direction 110, which can run around the mating direction 114.

The sealing sections 102 can be separated from plug connector walls or plug walls 404 extending in the mating direction 114, which can at least partially correspond to the interface wall 314, along the direction 202 transverse to the mating direction 114.

In FIG. 4, the end of the interface 318 is flush with the first end 228 of the sealing section 102. The ends, in particular the ends of the interfaces 318 and the ends 228 of the respective sealing section 102, can lie on a common plane 218, which runs perpendicular to the mating direction 114.

The second sealing section 106 can be configured identically to the first sealing section 104. During the installation of the sealing arrangement 100, the second sealing section 106 can be rotated by 180 degrees, for example in the direction 202 transverse to the mating direction 114, and installed relative to the first sealing section 104. Thus, the second end 234 of the first sealing section 104 can be identical to the first end of the second sealing section 106 and vice versa.

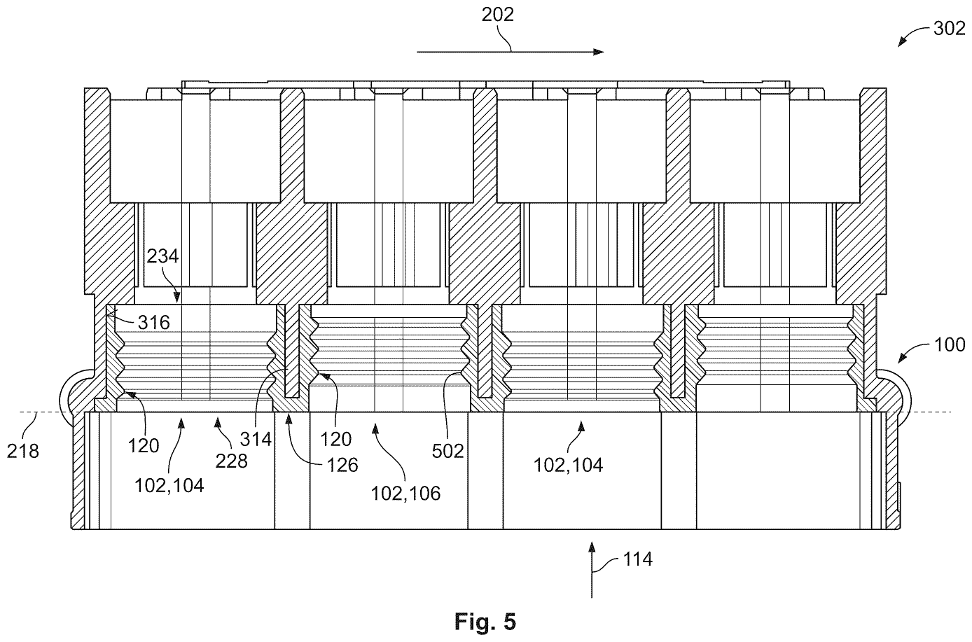

FIG. 5 shows an alternative embodiment of the plug connector 302 with a sealing arrangement 100, which is configured monolithically or in one piece. The ends 228, 234 of the respective sealing sections 102 can, in the monolithic configuration, be flush at at least one end, preferably the end facing a mating connector 310 or a mating connector plug 312, and be arranged on the common plane 218. The sealing sections 102 can not only be installed at the same height in the mating direction 114, but also be arranged next to each other along a longitudinal side along the direction 202 transverse to the mating direction 114. At at least one end 228, 234, for example the end facing the mating connector 310, the respective sealing sections 102 can be connected to each other with a material bridge 126 along at least one direction, for example the direction 202 transverse to the mating direction 114.

FIG. 5 also shows a depiction in which the sealing sections 102 are attached to the inner side 316 of the respective interface wall 314. In this embodiment, the sealing sections 102 are arranged alternately along the direction 202 transverse to the mating direction 114; thus, between two sealing sections 102 that have sealing projections 120 at the height of the first sealing section 104, a second sealing section 104 can be located, whose sealing projections 120 are offset in the mating direction 114 to the sealing projections of the first sealing section 104.

The tips 502 of the sealing projections 120 can be configured angularly or roundly. The sealing projections 120 can take on various forms to ensure reliable sealing.

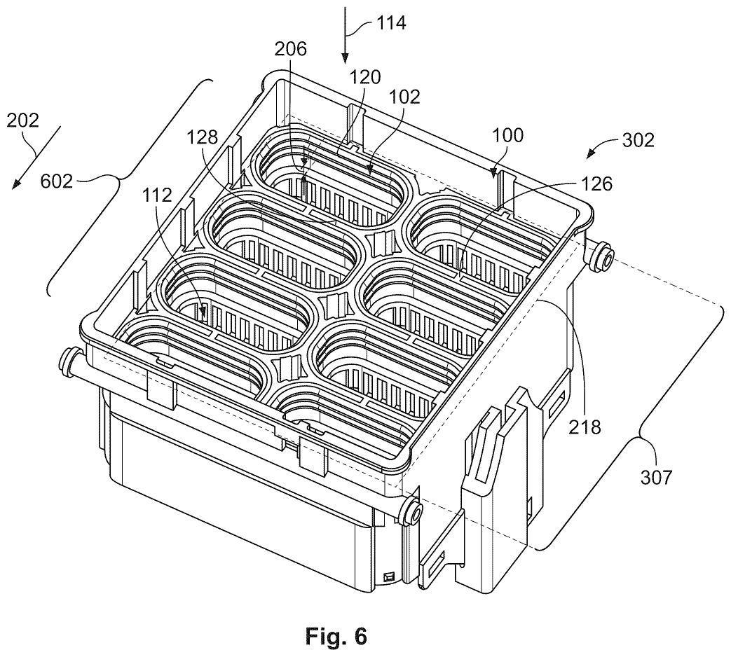

FIG. 6 shows a plug connector 302 with a sealing arrangement 100, which has a plurality of sealing sections 602. The sealing sections 102 of the plurality of sealing sections 602 can lie on a common plane 218. At least one end of each sealing section 102 facing the mating connector 310 in the mating direction 114 can lie on the common plane 218. The recesses 210 can be arranged here.

The plurality of sealing sections 602 can be monolithically or integrally formed and connected to each other by means of a material bridge 126 between every two sealing sections 102. The material bridge 126 can be arranged on a longitudinal side 128 of the sealing section 102, for example centrally on the longitudinal side 128. The material bridge 502 can have the same height or material thickness along the mating direction 114 as the sealing sections 102, which the material bridge 126 connects. The material bridge 126 can have a significantly smaller height or thickness and, for example, be smaller than or equal to the width 206 of a sealing projection 120 in the mating direction 114.

For example, four sealing sections 102 can be connected to each other along a direction 202 transverse to the mating direction 114. The sealing sections 102 do not necessarily all have to be connected to each other. In FIG. 6, four sealing sections 102 are respectively connected to each other along the direction 202 transverse to the mating direction 114. Along a direction perpendicular to the mating direction 114 and the direction 202 transverse to the mating direction 114, the sealing sections 102 are not connected.

The sealing sections 102 can end or be arranged on the same plane 218 as the plurality of interfaces 307 of the plug connector 302. The respective sealing sections 102 can be configured elliptically, as shown in FIG. 6. The sealing projections 120 can protrude towards the through-opening 112 of the respective sealing section 102.

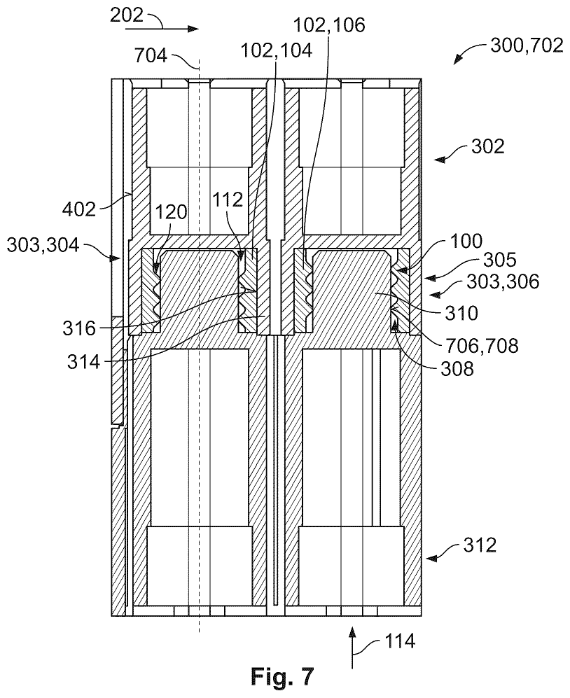

In FIG. 7, an electrical connection 300 is shown in the mated state 702. In this embodiment, the plug connector 302 has two interfaces 303, a first interface 304 and a second interface 306. Each of the interfaces 304, 306 can have an insertion opening 308, in which the sealing arrangement 100 or at least one sealing section 102 can be arranged. On the interface wall 314, for example on the inner side 316 of the interface wall 314, at least a part of the sealing arrangement 100 can be arranged.

The sealing projections 120 of the respective sealing sections 102 can protrude along the direction 202 transverse to the mating direction 114 towards the insertion opening 308 of the interface 303 or towards the through-opening 112 of the respective sealing section 102—in particular towards the center 704 of the sealing section or the through-opening 112 of the sealing section 102.

The through-opening 112 of the respective sealing section 102 and the insertion opening 308 of the sealing section 102 assigned interface 304, 306 can be configured concentrically to each other. The respective openings, the insertion opening 308 of the interface 304, 306 and/or the through-opening 112 of the sealing section 102 can be circular, elliptical, rectangular or polygonal. The respective sealing sections 102 can be adapted to the respective shape or contour of the insertion opening 308 of the interface 304, 306 and/or the through-opening 112 of the sealing section 102.

In the insertion opening 308 of the interface 304, 306 and in the through-opening 112 of the respective sealing section 102, a mating connector 310 of the mating connector plug 312 can be inserted. In this mated state 702, the sealing arrangement 100 seals the electrical connection 300 to the outside. One side 706 of the mating connector 310, for example an outer side 708 of the mating connector 310, can be supported on at least one sealing projection 120 of the respective sealing section 102.

The interface 304, 306 or the plug 305 can be configured as a female plug, into which the respective sealing section 102 of the sealing arrangement 100 is mounted. Alternatively, the interface 304, 306 or the plug 305 can be configured as a male plug, around which the respective sealing section 102 runs, for example around the mating direction 114. The sealing projections 120 in this case protrude in the direction 202 transverse to the mating direction 114 away from the outer side 402 of the plug connector 302 or the interface 303. The mating connector plug 312 can accordingly have female mating connectors 310 that can receive the male plugs 305.

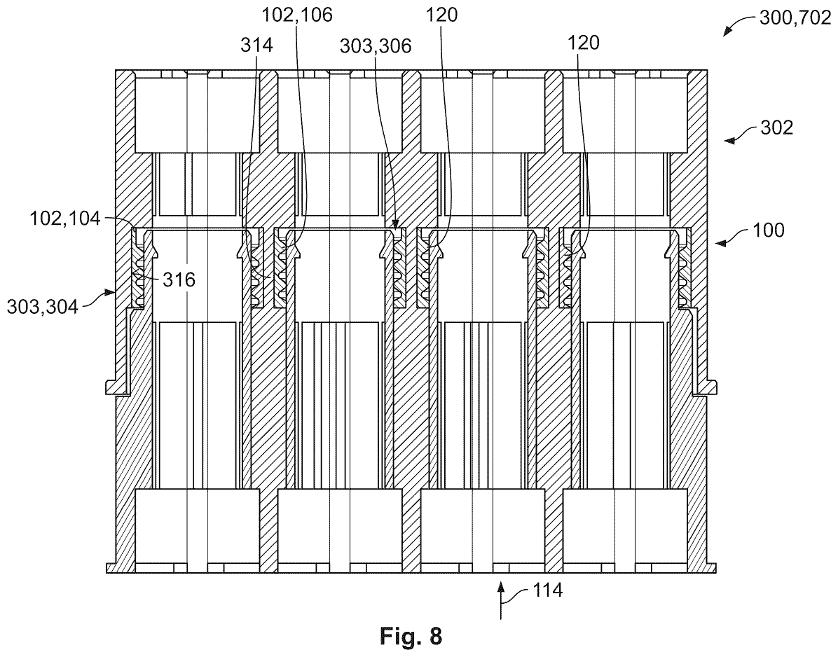

FIG. 8 shows another embodiment of the electrical connection 300 with a plug connector 302, which has a sealing arrangement 100 that is arranged on the inner side 316 of the respective interface wall 314.

The electrical connection 300 is shown in the mated state 702. The plug connector 302 can have four interfaces 303. A first sealing section 104 can be assigned or associated with a first interface 304. A second sealing section 106 can be assigned to a second interface 306. The reduction of the mating force along the mating direction 114 is achieved by the sealing projections 120 being offset in the mating direction 114. This requires less force to insert the mating connector 310 or the mating connector plug 312 into the plug connector 302 or to connect the mating connector plug 312 with the plug connector 302.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. Sealing arrangement for sealing an electrical connection, wherein the electrical connection has a plurality of interfaces, at which a plug and a mating connector of the electrical connection are matable with each other along a mating direction, wherein the sealing arrangement comprises:
a first sealing section, which is assigned to a first interface of the plurality of interfaces; and
a second sealing section, which is assigned to a second interface of the plurality of interfaces;
wherein the first and the second sealing section each have a plurality of sealing projections arranged one behind the other in the mating direction; and
wherein the sealing projections of the first sealing section are arranged offset in the mating direction to the sealing projections of the second sealing section.

2. Sealing arrangement according to claim 1, wherein the sealing projections are separated from each other in the mating direction by recesses; and wherein the sealing projections of the first sealing section are at the same height in the mating direction as the recesses of the second sealing section.

3. Sealing arrangement according to claim 1, wherein the sealing projections of the first and/or the sealing projections of the second sealing section are identically configured.

4. Sealing arrangement according to claim 1, wherein the sealing projections of the first sealing section and/or the sealing projections of the second sealing section are equally spaced from each other in the mating direction.

5. Sealing arrangement according to claim 1, wherein the width of the sealing projections of the first and/or the width of the sealing projections of the second sealing section along the mating direction is identical.

6. Sealing arrangement according to claim 1, wherein the distance between a first sealing projection and a first end of the first sealing section and/or the distance between a first sealing projection and a first end of the second sealing section along the mating direction is greater than the distance between two sealing projections of the first sealing section arranged one behind the other in the mating direction and/or between two sealing projections of the second sealing section arranged one behind the other in the mating direction.

7. Sealing arrangement according to claim 1, wherein the distance between a last sealing projection and a second end of the first sealing section and/or the distance between a last sealing projection and a second end of the second sealing section is smaller than or equal to the distance between two sealing projections of the first sealing section arranged one behind the other in the mating direction and/or between two sealing projections of the second sealing section arranged one behind the other in the mating direction.

8. Sealing arrangement according to claim 1, wherein the first and the second sealing section are arranged on a common plane perpendicular to the mating direction.

9. Sealing arrangement according to claim 1, wherein the first and the second sealing section are identically configured and the first sealing section is arranged next to the second sealing section, rotated by 180 degrees around an axis that runs perpendicular to the mating direction.

10. Sealing arrangement according to claim 1, wherein the first and/or the second sealing section extends along a circumferential direction transverse to the mating direction.

11. Sealing arrangement according to claim 1, wherein the sealing arrangement has three or more sealing sections for an electrical connection with three or more interfaces.

12. Plug connector comprising:
a plurality of interfaces; and
a sealing arrangement for sealing an electrical connection at which a plug of the plug connector and a mating connector of the electrical connection are matable with each other along a mating direction, the sealing arrangement including a first sealing section, which is assigned to a first interface of the plurality of interfaces, and a second sealing section, which is assigned to a second interface of the plurality of interfaces;
wherein the first and the second sealing section each have a plurality of sealing projections arranged one behind the other in the mating direction;
wherein the sealing projections of the first sealing section are arranged offset in the mating direction to the sealing projections of the second sealing section;
wherein, in the mated state, the first sealing section seals the first interface and the second sealing section seals the second interface.

13. Plug connector according to claim 12, wherein the first and/or the second sealing section is arranged on a wall of the respective first interface or second interface.

14. Plug connector according to claim 12, wherein the sealing projections are separated from each other in the mating direction by recesses; and wherein the sealing projections of the first sealing section are at the same height in the mating direction as the recesses of the second sealing section.

15. Plug connector according to claim 12, wherein the sealing projections of the first and/or the sealing projections of the second sealing section are identically configured.

16. Plug connector according to claim 12, wherein the sealing projections of the first sealing section and/or the sealing projections of the second sealing section are equally spaced from each other in the mating direction.

17. Plug connector according to claim 12, wherein the width of the sealing projections of the first and/or the width of the sealing projections of the second sealing section along the mating direction is identical.

18. Plug connector according to claim 12, wherein the distance between a first sealing projection and a first end of the first sealing section and/or the distance between a first sealing projection and a first end of the second sealing section along the mating direction is greater than the distance between two sealing projections of the first sealing section arranged one behind the other in the mating direction and/or between two sealing projections of the second sealing section arranged one behind the other in the mating direction.

19. Electrical connection comprising
a mating connector; and
a plug connector having a plug for mating with the mating connector in a mating direction, the plug connector including a plurality of interfaces and a sealing arrangement for sealing the electrical connection, the sealing arrangement including a first sealing section, which is assigned to a first interface of the plurality of interfaces, and a second sealing section, which is assigned to a second interface of the plurality of interfaces, wherein the first and the second sealing section each have a plurality of sealing projections arranged one behind the other in the mating direction, and wherein the sealing projections of the first sealing section are arranged offset in the mating direction to the sealing projections of the second sealing section;
wherein the sealing arrangement, in the mated state of the plug connector and mating connector, is arranged sealingly between the plug of the plug connector and the mating connector.

20. Electrical connection according to claim 19, wherein, in the mated state, the sealing projections of the sealing arrangement are supported on at least one of an inner side or an outer side of the mating connector.
